(19) United States
(12) Patent Application Publication
(10) Pub. No.: US 2025/0010576 A1
(43) Pub. Date: Jan. 9, 2025

(54) BICOLOR GROUND COVER

(71) Applicant: Emmanuel Abraham Ortiz Calderon, MORELIA (MX)

(72) Inventor: Emmanuel Abraham Ortiz Calderon, MORELIA (MX)

(21) Appl. No.: 18/712,663

(22) PCT Filed: Nov. 21, 2022
(86) PCT No.: PCT/US2022/050635

§ 371 Date: May 22, 2024

Related U.S. Application Data
(60) Provisional application No. 63/264,565, filed on Nov. 24, 2021.

(51) Int. Cl. B32B 7/023; A01G 13/02; B32B 3/26; B32B 5/02; B32B 27/12

(52) U.S. Cl. CPC B32B 7/023; A01G 13/0268; B32B 3/266; B32B 5/024; B32B 27/12; B32B 2250/02; B32B 2262/0253; B32B 2307/402; B32B 2307/7265; B32B 2307/7375; B32B 2410/00

(57) ABSTRACT

An agricultural ground cover system that includes a bicolor ground cover for placing on a soil substrate to control a temperature thereof, the bicolor ground cover can include a cover layer including a laminate film applied to a woven layer that includes a plurality of woven polypropylene filaments. A plurality of openings spaced at intervals within the bicolor ground cover can allow for plant growth. An upper side can be a white color and a lower side can be a black color. The cover layer can comprise a white color and then woven layer can comprise a black color.

### CROSS REFERENCE TO RELATED APPLICATIONS

This application claims the benefit of priority U.S. Provisional Patent Application No. 63/264,565, filed Nov. 24, 2021 and titled “BICOLOR GROUND COVER,” the contents of which are hereby incorporated by reference in their entirety. Any and all applications for which a foreign or domestic priority claim is identified in the Application Data Sheet as filed with the present application are hereby incorporated by reference under 37 CFR 1.57.

### BACKGROUND

### Field

This disclosure generally relates to agricultural ground or soil covers.

### Related Art

Agricultural soil covers are used for various purposes to treat soils and promote plant growth. These purposes include preventing weed growth, controlling moisture content and erosion, and controlling soil temperatures. Currently available soil covers include mulch films and ground covers. Mulch films are generally made of thin, blown films made of polyethylene or other polymers. Ground covers, on the other hand, are formed of more durable woven strands. The strands can be formed of polypropylene or other materials. There is a need for improved agricultural soil covers.

### SUMMARY OF CERTAIN INVENTIVE ASPECTS

Without limiting the scope of the claims, certain example embodiments are summarized below for illustrative purposes. Embodiments may include several novel features, no single one of which is solely responsible for its desirable attributes or which is essential to the embodiments.

In accordance with one aspect of the disclosure an agricultural ground cover system can include a bi-color ground cover placed over a soil substrate. The ground cover can include a woven layer including a plurality of woven polypropylene filaments and a cover layer comprising a laminate film applied to the woven layer. A plurality of openings can be spaced at intervals along a length of the ground cover. The openings can be configured for plant growth through the ground cover. A first substantially monochromatic outer side of the ground cover can be a first color and a second substantially monochromatic outer side of the ground cover can be a second color. The second color can be darker than the first color. The second color can be facing the soil substrate and the first color can be facing upwards.

In accordance with one aspect of the disclosure a ground cover can include a first outer side, a second outer side opposite the first outer side, a woven layer including a plurality of woven filaments, and a cover layer.

The first outer side can be a different color than the second outer side. The first outer side can be darker than the second outer side. The plurality of woven filaments can include polypropylene. The cover layer can be attached to the woven layer. The cover layer can be non-permeable to water. The first outer side can be a first substantially monochromatic outer side that can be a first color and the second outer side can be a second substantially monochromatic outer side that can be a second color. The first substantially monochromatic outer side can be on the cover layer and/or the second substantially monochromatic outer side can be on the woven layer. The first substantially monochromatic outer side can be on the woven layer and/or the second substantially monochromatic outer side can be on the cover layer. The first substantially monochromatic outer side can be a metallic color. The first substantially monochromatic outer side can include a metallized layer. The second substantially monochromatic outer side can be a substantially white color. The second substantially monochromatic outer side can be a substantially black color. The first substantially monochromatic outer side can be on the cover layer and/or the second substantially monochromatic outer side can be on the woven layer. The cover layer can include a lamination film, which can include: biaxially oriented polypropylene (BOPP), biaxially oriented polyethylene terephthalate (PET), and/or biaxially oriented nylon-6.

In accordance with one aspect of the disclosure a roll of ground cover can include a width between about 0.5 and about 6.0 meters, a length between about 1 and about 4000 meters, a woven layer including a plurality of woven polypropylene filaments, a cover layer laminated across the woven layer, a first outer side, and a second outer side. The first outer side can diffusely reflect substantially all visible light and the second outer side absorbs substantially all visible light. The roll can include any of the additional features disclosed herein.

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1A is a photograph of a field including a bicolor ground cover with a plurality of holes spaced at intervals through which plants can grow;

FIG. 1B is a schematic of a bicolor ground cover including a woven layer and a cover layer;

FIGS. 2A-B are photographs of a bicolor ground cover including a white woven layer and a black cover layer;

FIGS. 3A-B are photographs of the bicolor ground cover of FIGS. 2A-B in a roll.

### DETAILED DESCRIPTION

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

### Agricultural Soil Covers

Agricultural soil covers, including mulch films and ground covers can be used to control various aspects of a soil to facilitate crop growth. For example, weeds can compete aggressively for available resources, such as light and water, and can obscure and prevent good development of a desired crops. While herbicides can be used to keep crops free of weeds, many growers, especially growers of foods for human consumption, are reluctant to use herbicides because of contamination concerns. Agricultural soil covers applied to the soil can prevent or reduce the amount of sunlight from reaching the soil and limiting weed growth. Holes within the soil covers can enable crops planted within the soil access to sunlight.

As another example, the moisture content of a soil can be controlled using a soil cover. Some agricultural coverings (e.g., some types of mulch films) can be impermeable to water and can be used as a moisture barrier. A soil cover placed over a soil can prevent or inhibit the evaporation of water from the soil, prevent or inhibit erosion from rainfall or irrigation, and prevent or inhibit soil compaction.

Agricultural soil covers can also be used to stabilize or adjust soil temperatures, including raising or lowering of the soil temperature. For example, during cooler months, it can be desirable to raise soil temperatures, while during warmer months, it can be desirable to cool soil temperatures. The color of the soil cover can largely determine how much sunlight is reflected or absorbed by the soil cover. In turn, this can be used to alter soil temperatures. Agricultural soil covers, including mulch films and ground covers, generally are manufactured as monochromatic (e.g., white or black colors).

However, currently available mulch films and ground covers include several limitations in addressing the above problems. Mulch films are generally manufactured as a thin blown polyethylene sheet. Accordingly, mulch films tear easily, degrade over time, and generally have a relatively short useful life span. Often, mulch films are disposed of in ways that promote pollution. Woven ground covers are made out of a plurality of individual strands of a polymer material, particularly polypropylene, although other polymers could be used. The strands are woven into a woven layer. Woven ground covers, while more durable than mulch films, also have their limitations. The woven nature means that they are porous and often do little to act as a moisture barrier.

Mulch films are also manufactured in a single color (i.e., both top and bottom faces), aside from printed graphics or text. As a blown polymer sheet (e.g., polyethylene), the mulch films are a uniform color, which can vary depending on pigments used during manufacture. Woven ground covers are made out of a plurality of individual tapes or strands. Generally, woven ground covers are manufactured using strands of a single color (e.g., black or white), which makes both sides of the weave the same color (i.e., both top and bottom faces). Alternatively, multiple colors of woven strands or tapes can be used that create alternating patterns of the woven strands or tapes on both sides of the weave, neither of which would be monochromatic. The woven ground covers may also include portions with a different color to create stripes or other patterns. The usefulness of a soil cover can be limited based on being a single color. Accordingly, a need exists for improving agricultural soil covers.

### Bi-Color Ground Cover

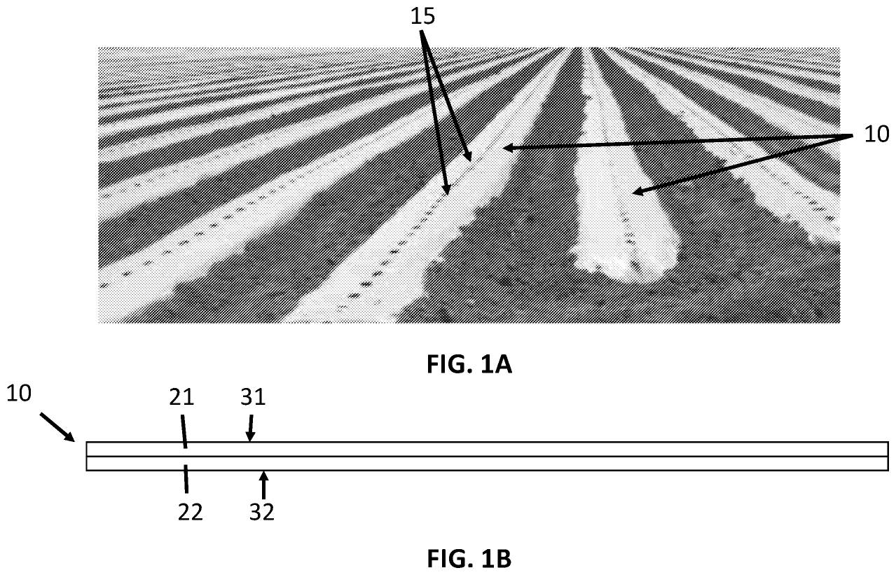

FIG. 1A shows exemplary ground covers 10 arranged in rows within a field. The ground cover 10 can be unrolled from a roll and placed over portions of the soil in a field. After being placed over the soil, one or more edges of the ground cover 10 can be secured in-place by soil placed on top or agricultural staples or the like. One or more holes 15 can be cut within the ground cover 10. The holes 15 can be cut or pre-formed at intervals. The holes 15 can facilitate growth of a plant in the soil through the apertures 15.

FIG. 1B shows a side view of the ground cover 10. The ground cover 10 can include a cover layer 21 and a woven layer 22. The cover layer 21 can comprise a polypropylene material. Alternatively, the cover layer 21 can comprise polyethylene, biaxially oriented polypropylene (BOPP), biaxially oriented polyethylene terephthalate (PET), biaxially oriented nylon material such as Nylon 6, or another polymer. The cover layer 21 can comprise a laminate. The polymer or polymer blend of the cover layer 21 may incorporate agents such as one or more pigments, UV stabilizers, or processing aids.

The cover layer 21 can be applied to an outer surface of the woven layer 22 using a film coating line. The cover layer 21 can be formed from an extrusion/melting machine and applied onto the woven layer 22. The cover layer 21 can be formed from a resin heated in a laminate machine and applied as a heated resin directly onto the woven layer 22. Alternatively, the cover layer 21 can comprise a preformed film material that is attached with one surface of the woven layer 22. The cover layer 21 can be attached with the woven material 22 using an adhesive applied to the cover layer 21 and/or the woven layer 22.

The cover layer 21 can be a thin, flexible material. The cover layer 21 can have a thickness less than a thickness of the woven layer 22. The thickness of the cover layer 21 can be between 5 and 50 μm. For example, the thickness of the cover layer can be about 5 μm, about 10 μm, about 15 μm, about 20 μm, about 25 μm, about 30 μm, about 35 μm, about 40 μm, about 45 μm, about 50 μm, or any values or ranges between any of these values, although other configurations are possible. Optionally, the cover layer 21 can include multiple laminate layers. In some embodiments, the cover layer 21 can be impermeable to water and/or air.

The cover layer 21 can comprise one or more pigments providing the cover layer 21 with a color. The cover layer 21 can be substantially monochromatic. By way of example, at least about 98%, about 95%, about 90%, about 85%, or about 80% of a face (e.g., the outer face 31) of the cover layer 21 can be the same color, or any values or ranges between these values, although other configurations are possible. The cover layer 21 can include an outer face 31. The outer face 31 can be light (e.g., diffusely reflects most or substantially all visible light) or dark (e.g., absorbs most or substantially all visible light). In certain examples, the light color of the outer face 31 can be can be white. In some examples, the dark color can be black. The light color can reflect (e.g., diffusely) about 70%, about 75%, about 80%, about 85%, about 90%, about 95%, about 98%, about 99% or more of incoming visible light, or any values or ranges between any of these numbers, although other configurations are possible. The dark color can absorb about 70%, about 75%, about 80%, about 85%, about 90%, about 95%, about 98%, about 99% or more of incoming visible light, or any values or ranges between any of these numbers, although other configurations are possible.

The woven layer 22 can comprise a woven polymer. The woven layer 22 can comprise a plurality of woven filaments (e.g., tapes or strands). The woven layer 22 can include filaments woven in two directions (e.g., warp and weft) to form a fabric. The woven layer 22 can be woven according to a pattern (e.g., plain (1:1, 1:2, 2:2, etc.), twill, herringbone, etc.). The properties of the weave can include the tightness of the weave, the amount of space left between adjacent strands, the tightness of the warp relative to the weft. Water may or may not be able to pass through the woven layer 22, depending on the tightness of the weave.

The filaments can be formed as having a circular, rectangular, flat, or other cross-sectional shapes. The filaments can comprise polypropylene or other polymer material. Desirably, polypropylene can be used because it is resistant to degradation, tearing, and can bond with the laminate materials of the cover layer 21. In some embodiments, substantially all of the weft filaments comprise a first type of filament and the warp filaments are a second type of filament, which can be different from the first type of filament (e.g., different material, shape, or color). In other embodiments, the weft and warp filaments can be the same. The filaments may be formed from any suitable polyolefin such as polyethylene or polypropylene, for example, or a mixture thereof, or an ethylene alpha-olefin, or a polyester, or a biopolymer, or a blend of any of the foregoing. Certain plastics are also useful when present as minor or major components including: ethylene vinyl acetate (EVA), ethylene butyl acrylate (EBA) and ethylene methyl acrylate (EMA) (for imparting elasticity), polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate. The polymer or polymer blend may incorporate agents such as one or more pigments, UV stabilizers, or processing aids. The filaments can have a denier weight of approximately 15 grams/meter or between 5 and 50 grams/meter. The ground cover 10 (including the cover layer 21 and the woven layer 22) can gave a weight of about 100 grams per square meter (GSM) or in the range of 50 to 300 GSM.

The woven layer 22 can include an outer face 32. The outer face 32 can be on an opposite side of the groundcover 10 as the outer face 31. The woven layer 22 can be substantially monochromatic. By way of example, at least about 98%, about 95%, about 90%, about 85%, or about 80% of the outer face 32 of the woven layer 22 can be the same color, or any values or ranges between any of these numbers, although other configurations are possible. The woven layer 22 can include filaments that are all substantially the same color and/or same material. Coloring in polypropylene can be created using dyes or pigments during the production process for the polypropylene filaments. The woven layer 22 can be light (e.g., diffusely reflects most or substantially all visible light) or dark (e.g., absorbs most or substantially all visible light). In certain examples, the light color of the outer face 32 can be can be white. In some embodiments, the dark color can be black. The light color can reflect (e.g., diffusely) about 70%, about 75%, about 80%, about 85%, about 90%, about 95%, about 98%, about 99% or more of incoming visible light, or any values or ranges between any of these numbers, although other configurations are possible. The dark color can absorb about 70%, about 75%, about 80%, about 85%, about 90%, about 95%, about 98%, about to 99%, or more of incoming visible light, or any values or ranges between any of these numbers, although other configurations are possible.

The outer face 31 can be a different color than the outer face 32. The outer face 31 can be a lighter color than the outer face 32. The outer face 31 can be a darker color than the outer face 32. The outer face 31 can be substantially monochromatic. The outer face 32 can be substantially monochromatic. The outer face 32 can include outer surfaces of the filaments of the woven material 22. The monochromatic nature of the second side 32 can be based on the color of the woven filaments. These can be substantially monochromatic creating a substantially monochromatic outer face 32. The outer face 31 can be substantially white and the outer face 32 can be substantially black. The outer face 31 can be substantially black and the outer face 32 can be substantially white.

The ground cover 10 can be used to alter the temperature of a soil. In one example, the soil temperature can be raised so that plant roots can be in better condition for development. In some cases, the ground cover 10 can stabilize the soil temperature, such as by reducing variations in temperature during warmer times (e.g., day time or summer time) and cooler times (e.g., night time or winter time). The ground cover 10 (e.g., the cover layer 21) can be substantially impermeable to moisture and/or air, which can impede evaporation from the soil, which can aid keep the temperature of the soil warm or stable. Impeding evaporation can aid in keeping the soil moist and can reduce the amount of water consumption and/or can reduce the frequency of watering. The ground cover 10 can be less permeable to water and/or air as compared to a woven ground cover with no cover layer 21. The colors of the ground cover 10 can be important, as discussed above, for controlling the thermal response of the soil. Depending on the desired usage (e.g., soil or weather conditions), the light/dark ground cover 10 can be used or the dark/light ground cover 10 can be used. Having different colors of the materials of the ground cover including the cover layer 21 and the material layer 22 can add further options for creating the desired thermal response in the soil. While a mulch film or ground cover could be used alone, the ground cover 10 offers certain benefits over conventional agricultural soil covers.

According to one example, a white cover layer 21 and a black woven layer 22 are used. Alternatively, a white woven layer 22 can be used with a black cover layer 21. Various different colors could be used for the woven layer 22 and the cover layer 21. The black surface (e.g., surface 32) can face downward towards the soil, and the white surface (e.g., surface 31) can face upward, in some implementations. During cooler months, the available light is relatively short in duration. The white or light colored surface that faces up can reflect or otherwise provide additional light to a plant (e.g., growing over the ground cover 10). The ground cover 10 can improve soil temperature (e.g., by warming the soil or by regulating temperature). In some implementations, to improve ground temperature quickly, the ground cover 10 with the white cover layer 21 and black woven layer 22 can be place over the ground with white cover layer facing up. While the use of the white on the upper face can seem non-intuitive, the cover layer 21 does not face or contact the soil, but the woven material 22 can face or touch the soil. Heat can get trapped in the cover layer 21 and be transmitted to the soil through the woven layer 22. In certain implementations, the heat radiation rate on a white coating is about 80%, about 85%, or about 90% (which can be close to transparent film), or any values or ranges between these percentages, although other configurations are possible. The black coloring of the woven layer 22 can more easily transmit heat to the soil in the form of infrared energy, in some implementations. The ground cover 10 can have a light transmittance of about 40%, about 35%, about 30%, or less, or any values or ranges therebetween, although other configurations are possible. The ground cover 10 can block more than 70% or more of incoming light from reaching a ground surface. The ground cover 10 can be configured to transfer a majority of the heat energy to the soil under the ground cover 10, while transmitting only a fraction of the light that impinges on the ground cover 10.

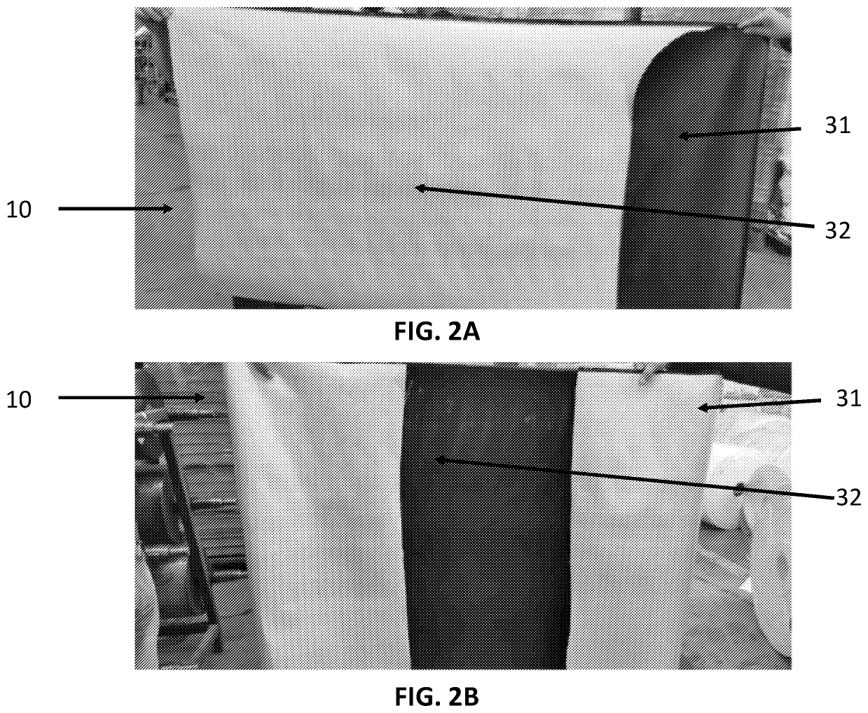

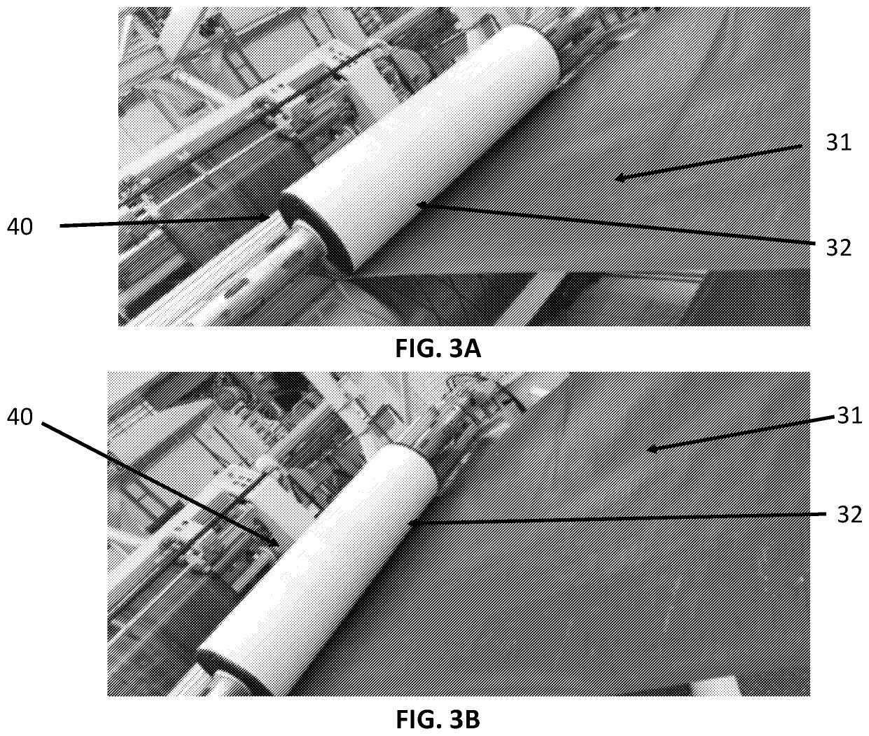

The ground cover 10 can have a substantially uniform thickness across its length and width (e.g., the thickness can vary slightly based on the contours of the woven material 22). The ground cover 10 can be manufactured in very long lengths, as shown in the samples in FIGS. 2A-B and the rolls 40 of the ground cover 10 in FIGS. 3A-B. The length of the roll 40 can be about 1 meter, about 2 meters, about 5 meters, about 10 meters, about 15 meters, about 25 meters, about 50 meters, about 75 meters, about 100 meters, about 125 meters, about 150 meters, about 200 meters, about 250 meters, about 300 meters, about 350 meters, about 400 meters, about 500 meters, about 700 meters, about 1000 meters, about 2000 meters, about 3000 meters, or about 4000 meters, or more, or any values threrebetween, or any ranges between any of these value, although other configurations are possible. The width of the roll 40 can be about 0.5 meters, about 0.75 meters, about 1 meter, about 1.25 meters, about 1.5 meters, about 1.75 meters, about 2 meters, about 2.5 meters, about 3 meters, about 3.5 meters, about 4 meters, about 5 meters, about 6 meters, or more, or any values therebetween, or any ranges between any of these values, although other sizes are possible.

In some embodiments, the cover layer 21 can be metallized. In some embodiments, particles of metal can be used in a pigment to form the polymer material of the cover layer 21. Aluminum, nickel, chromium, or any other suitable metal material can be used. In some implementations, the cover layer 21, either before or after attachment with the woven layer 22, can be coated with a thin metal. For example, a metalized coating can include a thin layer of metal on the cover layer 21 applied through a physical vapor deposition process or other process. The metal film can include an aluminum, nickel, chromium or other material. Through the physical vapor deposition process, a metal is heated and evaporated in a vacuum and condenses on the polymer film (sublimation), for example. In some embodiments, the polymer cover layer can have a metal film disposed thereon. In some embodiments, a metal film can be the cover layer. For example, the metal film can be deposited onto one side of the woven layer 22. In some embodiments, a metal film can be laminated onto the woven layer 22 or onto the cover layer 21. In some embodiments, a metal film can be adhered to the woven layer 22 or to the cover layer 21. In some embodiments, the polymer used to make the woven layer 22 can be metalized, such as having metal particles in a pigment used to make the polymer.

The metalized surface of the ground cover 10 (e.g., the cover layer 21) can be more or less reflective of light than the white color (or similar reflectivity as the white color as discussed herein). The metalized ground cover 10 can be used to alter the temperature of a soil. The outer face 31 can be a metalized color. The outer face 31 can be a lighter color than the outer face 32. The outer face 31 can be substantially monochromatic in the metalized color. The outer face 32 can be substantially monochromatic. The outer face 32 can include outer surfaces of the filaments of the woven material 22. The outer face 32 can be substantially dark or black. Alternatively, the outer face 32 can be light or white. In other embodiments, the outer face 32 can be metalized, and in some cases the outer surface 31 can be substantially monochromatic black or white, or any other suitable color. A metalized surface of the ground cover 10 can be installed facing upward, which can reflect light upward to a plant that is growing through or above the ground cover 10. In some implementations, reflecting additional light in this manner can deter pests, such as white flies and aphids, which can carry disease. The use of metalized ground cover 10 can provide smaller variations in soil temperature between the heat of the day and the cold of night. The metalized ground cover 10 can also provide barrier properties, which can improve the effectiveness of fumigation or reduce the amount of fumigation that is used. The metal layer (e.g., coating) can be applied to either a black or while base material, such as depending on the time of year, temperature, or other conditions.

### Certain Terminology

Terms of orientation used herein, such as “top,” “bottom,” “upper,” “lower,” “inner,” “outer,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

### SUMMARY

Several illustrative examples of soil covers have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of soil covers and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims.

What is claimed is:

1. An agricultural ground cover system comprising:
a bi-color ground cover placed over a soil substrate, comprising:
a woven layer including a plurality of woven polypropylene filaments; and
a cover layer comprising a laminate film applied to the woven layer;
a plurality of openings spaced at intervals along a length of the ground cover, the openings configured for plant growth through the ground cover;
wherein a first substantially monochromatic outer side of the ground cover is a first color and a second substantially monochromatic outer side of the ground cover is a second color, the second color being darker than the first color;
wherein the second color is facing the soil substrate and the first color is facing upwards.

2. A ground cover comprising:
a first outer side;
a second outer side opposite the first outer side;
a woven layer including a plurality of woven filaments; and
a cover layer.

3. The ground cover of claim 2, wherein the first outer side is a different color than the second outer side.

4. The ground cover of claim 2, wherein the first outer side is darker than the second outer side.

5. The ground cover of claim 2, wherein the plurality of woven filaments comprise polypropylene.

6. The ground cover of claim 2, wherein the cover layer is attached to the woven layer.

7. The ground cover of claim 2, wherein the cover layer is non-permeable to water.

8. The ground cover of claim 2, wherein the first outer side is a first substantially monochromatic outer side that is a first color and the second outer side is a second substantially monochromatic outer side that is a second color.

9. The ground cover of claim 8, wherein the first substantially monochromatic outer side is on the cover layer and the second substantially monochromatic outer side is on the woven layer.

10. The ground cover of claim 8, wherein the first substantially monochromatic outer side is on the woven layer and the second substantially monochromatic outer side is on the cover layer.

11. The ground cover of claim 8, wherein the first substantially monochromatic outer side is a metallic color.

12. The ground cover of claim 11, wherein the first substantially monochromatic outer side includes a metallized layer.

13. The ground cover of claim 12, wherein the second substantially monochromatic outer side is a substantially white color.

14. The ground cover of claim 12, wherein the second substantially monochromatic outer side is a substantially black color.

15. The ground cover of any of claims 8-14, wherein the first substantially monochromatic outer side is on the cover layer and the second substantially monochromatic outer side is on the woven layer.

16. The ground cover of any of the above claims, wherein the cover layer includes a lamination film comprising: biaxially oriented polypropylene (BOPP), biaxially oriented polyethylene terephthalate (PET), or biaxially oriented nylon-6.

17. A roll of ground cover comprising:
a width between 0.5 and 6.0 meters;
a length between 1 and 4000 meters;
a woven layer including a plurality of woven polypropylene filaments;
a cover layer laminated across the woven layer;
a first outer side; and
a second outer side;
wherein the first outer side diffusely reflects substantially all visible light and the second outer side absorbs substantially all visible light.

18. The roll of claim 17, wherein the first outer side is a different color than the second outer side.

19. The roll of claim 17, wherein the first outer side is darker than the second outer side.

20. The roll of claim 17, wherein the cover layer is attached to the woven layer.

21. The roll of claim 17, wherein the cover layer is non-permeable to water.

22. The roll of claim 17, wherein the first outer side is a first substantially monochromatic outer side that is a first color and the second outer side is a second substantially monochromatic outer side that is a second color.

23. The roll of claim 22, wherein the first substantially monochromatic outer side is on the cover layer and the second substantially monochromatic outer side is on the woven layer.

24. The roll of claim 22, wherein the first substantially monochromatic outer side is on the woven layer and the second substantially monochromatic outer side is on the cover layer.

25. The roll of claim 22, wherein the first substantially monochromatic outer side is a metallic color.

26. The roll of claim 25, wherein the first substantially monochromatic outer side includes a metallized layer.

27. The roll of claim 26, wherein the second substantially monochromatic outer side is a substantially white color.

28. The roll of claim 26, wherein the second substantially monochromatic outer side is a substantially black color.

29. The roll of any of claims 22-28, wherein the first substantially monochromatic outer side is on the cover layer and the second substantially monochromatic outer side is on the woven layer.

30. The roll of any one of claims 17-29, wherein the cover layer includes a lamination film comprising: biaxially oriented polypropylene (BOPP), biaxially oriented polyethylene terephthalate (PET), or biaxially oriented nylon-6.
